(19) United States
(12) Patent Application Publication
(10) Pub. No.: US 2009/0219452 A1
(43) Pub. Date: Sep. 3, 2009

(54) ELECTRONIC APPARATUS AND DISPLAY CONTROL METHOD

(75) Inventors: Jiro Morikawa, Kumagaya-shi (JP); Kazumasa Oura, Fukaya-shi (JP); Yu Onodera, Kumagaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/274,177

(22) Filed: Nov. 19, 2008

(30) Foreign Application Priority Data
Feb. 29, 2008 (JP) 2008-050877

(51) Int. Cl. H04N 5/44

(52) U.S. Cl. 348/734; 348/E05.096

(57) ABSTRACT

According to one embodiment, an electronic apparatus which displays image data input from an input source on a display screen, the apparatus includes a communication unit which communicates with an external apparatus, a menu display processing unit which displays an operation menu to operate the electronic apparatus on the display screen, a receiving unit which receives a control signal transmitted from a remote control unit, and a control unit which determines whether the operation menu is displayed on the display screen when the control signal received by the receiving unit is a control signal adapted for both control of the external apparatus and operation of the operation menu, and executes operation of the operation menu in accordance with the received control signal when the operation menu is displayed on the display screen.

### CROSS-REFERENCE TO RELATED APPLICATIONS

This application is based upon and claims the benefit of priority from Japanese Patent Application No. 2008-050877, filed Feb. 29, 2008, the entire contents of which are incorporated herein by reference.

### BACKGROUND

1. Field

One embodiment of the present invention relates to a television control technique, and particularly to an electronic apparatus and display control method, which allows a comfortable operation in a case where the television displays an operation menu to switch inputs.

2. Description of the Related Art

According to the generally-known art, an external apparatus connected to a television via an HDMI (High Definition Multimedia Interface) digital bus is operated from the television by communication utilizing an HDMI-CEC control signal.

For example, Jpn Pat. Appln. KOKAI Publication No. 2006-41584 discloses a technique of operating a television and an external apparatus connected thereto via an HDMI digital bus by using a common operation button of a single remote controller unit. In this technique, the objects of operation can be switched between by mode setting (TV mode or external apparatus mode) by a push of the operation button.

According to the technique disclosed in Jpn. Pat. Appln. KOKAI Publication No. 2006-41584, however, when the television displays an operation menu for input switching, if operation buttons corresponding to both the operation menu and the external apparatus are pushed, the push of the operation buttons is recognized as an operation for controlling the external apparatus. In this case, the operation menu cannot be operated.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic diagram snowing an example of the configuration of an electronic apparatus according to an embodiment of the present invention;

FIG. 2 is an exemplary block diagram showing the configuration of the electronic apparatus of the embodiment;

FIG. 3 is an exemplary schematic diagram showing a configuration of a remote control unit for use in a remote control operation of the electronic apparatus of the embodiment;

FIG. 4 is an exemplary diagram showing the relationship between an operation button provided in the remote control unit shown in FIG. 3 and an input mode;

FIG. 5 is an exemplary flowchart for explaining a process sequence executed by the electronic apparatus of the embodiment in reply to a received remote control code;

FIG. 6 is an exemplary diagram showing an example of an on-screen display in the electronic apparatus of the embodiment;

FIG. 7 is an exemplary diagram showing another example (display for selection by a lateral movement) of the on-screen display in the electronic apparatus of the embodiment;

FIG. 8 is an exemplary diagram showing still another example (display for angle-of-view adjustment by selection) of the on-screen display in the electronic apparatus of the embodiment;

FIG. 9 is an exemplary diagram showing still another example (display for picture quality adjustment by selection) of the on-screen display in the electronic apparatus of the embodiment;

FIG. 10 is an exemplary diagram showing still another example (display for subtitle adjustment by selection) of the on-screen display in the electronic apparatus of the embodiment; and

FIG. 11 is an exemplary diagram showing still another example (display for sound switch by selection) of the on-screen display in the electronic apparatus of the embodiment.

### DETAILED DESCRIPTION

Various embodiments according to the invention will be described hereinafter with reference to the accompanying drawings. In general, according to one embodiment of the invention, an electronic apparatus which displays image data input from an input source on a display screen, the apparatus includes: a communication unit which communicates with an external apparatus; a menu display processing unit which displays an operation menu to operate the electronic apparatus on the display screen; a receiving unit which receives a control signal transmitted from a remote control unit; and a control unit which determines whether the operation menu is displayed on the display screen when the control signal received by the receiving unit is a control signal adapted for both control of the external apparatus and operation of the operation menu, and executes operation of the operation menu in accordance with the received control signal when the operation menu is displayed on the display screen.

An embodiment of the present invention will be described below with reference to the accompanying drawings.

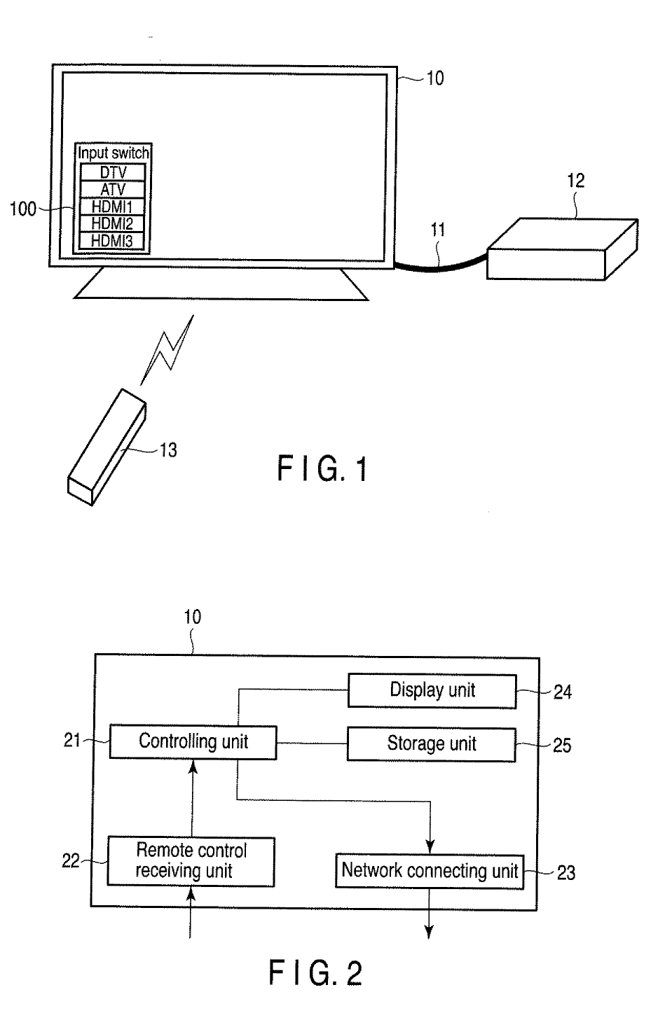

First, a configuration of an electronic apparatus according to an embodiment of the present invention will be described with reference to FIGS. 1 and 2. The electronic apparatus is implemented as, for example, a television 10. In the following description of the embodiment, the electronic apparatus is described as the television 10, but it may be an electronic apparatus having only a monitoring function connected to a tuner.

The television 10 is connected to an external apparatus 12 via an HDMI (High-Definition Multimedia interface) cable 11. The external apparatus 12 may be, for example, a DVD recorder. The television 10 and the external apparatus 12 are both adapted to an HDMI-CEC (Consumer Electronics Control) control signal. The HDMI-CEC control signal can transfer a control signal received from a remote control unit 13 for the television 10 to an apparatus connected to the television 10 via the HDMI cable 11. For example, when the remote control unit 13 transmits a playback instruction signal (remote control code) to instruct playback of a recorded program, the television 10 receives the playback instruction signal. When the television 10 determines that the received playback instruction signal is a control signal for the external device 12, for example, a DVD player, connected via the HDMI cable 11, it transmits a playback instruction signal to the DVD player via the HDMI cable 11, thereby controlling (playing back) the DVD player. In this embodiment, the present invention is applied to the electronic apparatus adapted to the HDMI-CEC control signal, but is not limited thereto. The electronic apparatus may be of any type as far as it is configured to display the on-screen display 100 and control an external apparatus connected thereto by the remote control unit 13.

When the user pushes an input switch button of the remote control unit 13, the television 10 receives an input switching signal (remote control code to instruct input switching) transmitted from the remote control unit 13. When the television 10 receives the input switching signal, it displays the on-screen display 100. On the on-screen display (OSD operation menu) 100, an operation menu to switch between a plurality of input sources provided on the television 10 is displayed. In the state where the on-screen display 100 is displayed, the user can select one of the input sources (DTV, ATV, HDMI1, HDMI2 and HDMI3) displayed on the on-screen display 100 by operating a cross button or the like of the remote control unit 13.

The configuration of the television 10 will now be described with reference to FIG. 2.

As shown in FIG. 2, the television 10 comprises a controlling unit 21, a remote control receiving unit 22, a network connecting unit 23, a display unit 24 and a storage unit 25.

The control unit 21 is a central controlling device, which exercises control over operations of the television 10 and transmission and reception of a variety of commands. The remote control receiving unit 22 is a receiving unit which receives control signals (remote control codes) or the like transmitted from the remote control unit 13. The network connecting unit 23 is a communication unit which carries out communications with an external apparatus through the HDMI cable 11 described above. The display unit 24 is a display processing unit which displays video data input from the input source on a display screen of a display panel in the television 10. The display 24 also carries out a process of displaying the on-screen display 100 on the display screen under the control of the control unit 21. The storage unit 25 is a storage device, such as a flash memory, which stores the received control signals (remote control codes) or the like.

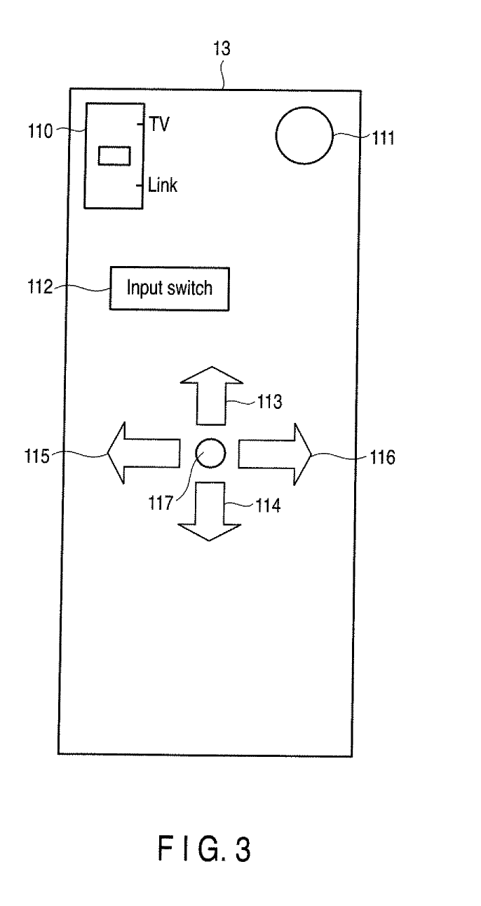

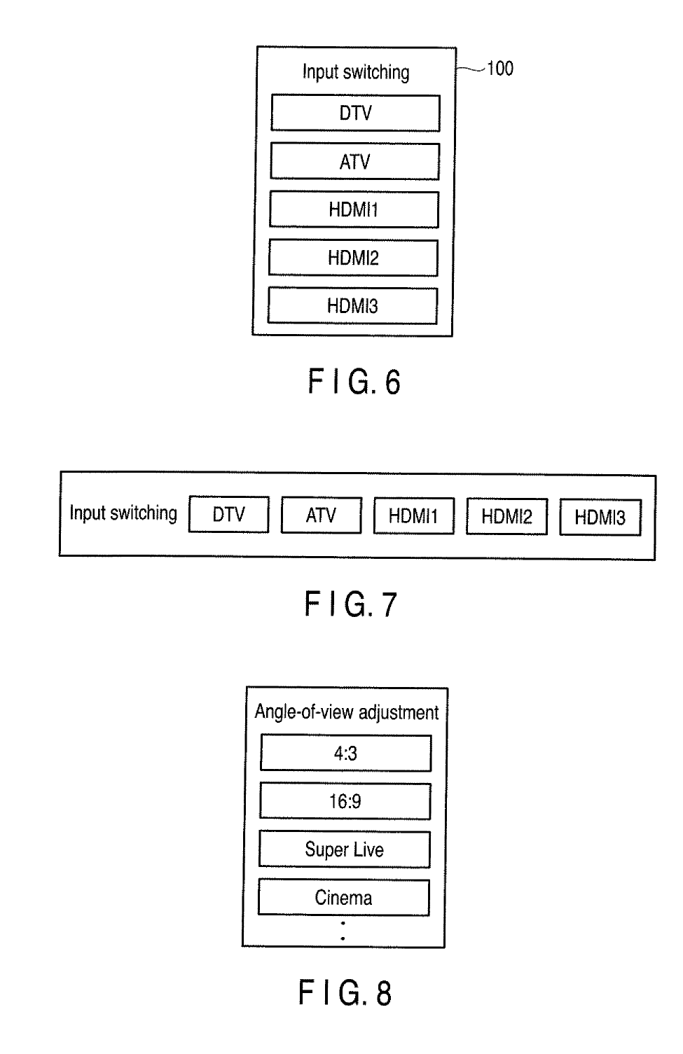

The remote control unit 13, as shown in FIG. 3, comprises a power supply button 111, a mode change switch 110, an input switch button 112, direction buttons 113-116, an enter button 117, etc. The mode change switch 110 switches between a “TV mode” for transmitting a control signal which controls the television 10 and a “link mode” for controlling the external apparatus 12 connected to the television 10 via the HDMI cable 11. The input switch button 112 is an operation button to display the on-screen display 100 (FIG. 6) on the television 10. When the user pushes the input switch button 112, the on-screen display 100 is displayed on the television 10. When the input switch button 112 is pushed again, the input source for the television 10 can be changed to one of the input sources (DTV: digital broadcast, ATV: analog broadcast, and HDMI1-3: apparatuses connected to the HDMI cable 11) currently selected on the on-screen display 100. For example, when the input source is switched to DTV, video data contained in broadcast data received by a digital broadcast tuner in the television 10 is displayed on the display screen of the television 10. Alternatively, for example, when the input source is switched to ATV, video data contained in broadcast data received by an analog broadcast tuner in the television 10 is displayed on the display screen of the television 10.

The input source can also be switched (selected) by up and down keys 113 and 114 of the direction keys 113-116.

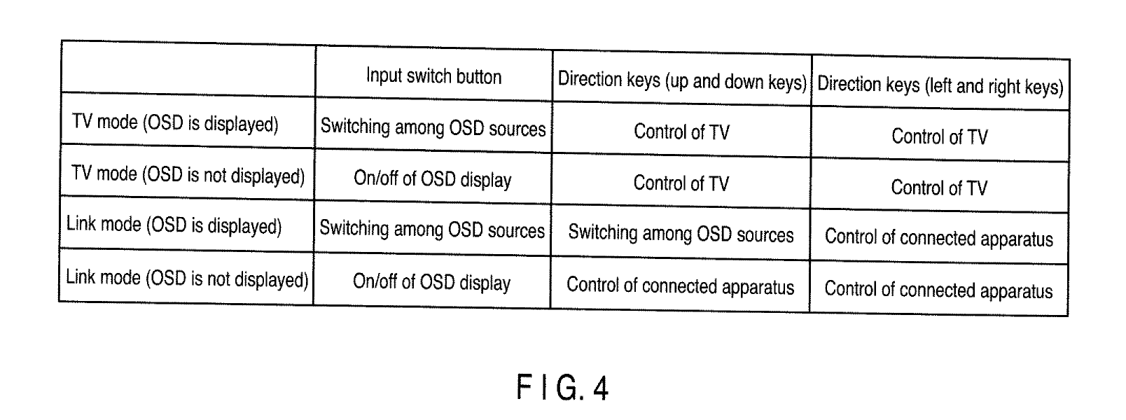

FIG. 4 is a schematic diagram showing operations executed by the buttons of the remote control unit 13 in the respective input modes.

In the case where the “TV mode” has been set by the mode change switch 110 and when the on-screen display 100 is displayed, the input switch button 112 functions as an operation button to switch the input source to display video data to be displayed among the input sources displayed on the on-screen display 100. The direction keys (up and down keys) 113 and 114 and direction keys (left and right keys) 115 and 116 function as operation buttons to control operations of the television 10.

In the case where the “TV mode” has been set by the mode change switch 110 and when the on-screen display 100 is not displayed, the input switch button 112 functions as an operation button which instructs to turn on and off the display of the on-screen display 100. The direction keys (up and down keys) 113 and 114 and direction keys (left and right keys) 115 and 116 function as operation buttons to control operations of the television 10.

In the case where the “link mode” has been set by the mode change switch 110 and when the on-screen display 100 is displayed, the input switch button 112 functions as an operation button to switch the input source of the television 10 among the input sources displayed on the on-screen display 100. The direction keys (up and down keys) 113 and 114 also function as operation buttons to switch the input source of the television 10 among the input sources displayed on the on-screen display 100. The direction keys (left and right keys) 115 and 116 function as operation buttons to control the external apparatus 12. When the direction key (left or right key) 115 or 116 is pushed, the on-screen display 100 is erased (if a control signal adapted to an external apparatus is received through the receiving unit with the operation menu displayed on the display unit, the television 10 erases the operation menu and processes the received control signal as a control signal adapted to the external apparatus).

In the case where the “link mode” has been set by the mode change switch 110 and when the on-screen display 100 is not displayed, the input switch button 112 functions as an operation button which instructs to turn on and off the display of the on-screen display 100. The direction keys (up and down keys) 113 and 114 and the direction keys (left and right keys) 115 and 116 function as operation buttons to control the external apparatus 12.

In the above embodiment, the input source switch menu displayed on the on-screen display 100 is selected by up and down key movement (FIG. 6). However, the present invention is not limited to this embodiment. For example, as shown in FIG. 7, the input source switch menu displayed on the on-screen display 100 may be selected by left and right key movement. In this case, the direction keys (up and down keys) 113 and 114 are not effective for the on-screen display 100, whereas the direction keys (left and right keys) 115 and 116 are effective for the on-screen display 100.

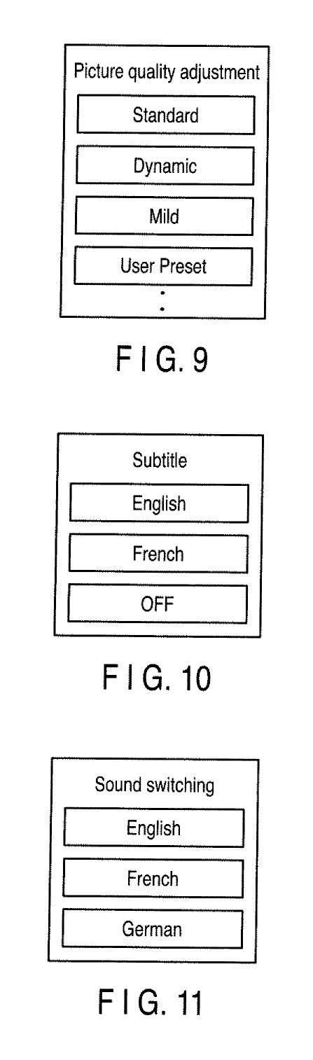

The operation menu displayed on the on-screen display 100 is not limited to the switching among the input sources. For example, as shown in FIG. 8, angle-of-view adjustment may be displayed on the on-screen display 100. In this case, the angle-of-view can be adjusted to desired one of “4:3”, “16:9”, “Super Live”, “Cinema”, etc. by selection operation. Further, as shown in FIG. 9, picture quality adjustment may be displayed on the on-screen display 100. In this case, the picture quality can be adjusted to desired one of “Standard”, “Dynamic”, “Mild”, “User Preset”, etc. by selection operation. Further, as shown in FIG. 10, subtitle adjustment may be displayed on the on-screen display 100. In this case, the language of the subtitle may be switched to “English”, “French”, “Off (no subtitle)”, etc. by selection operation. Furthermore, as shown in FIG. 11, sound adjustment may be displayed on the on-screen display 100. In this case, the language of the sound may be switched to “English”, “French”, “German”, etc. by selection operation. Thus, various display forms are applicable to the operation menu displayed on the on-screen display 100.

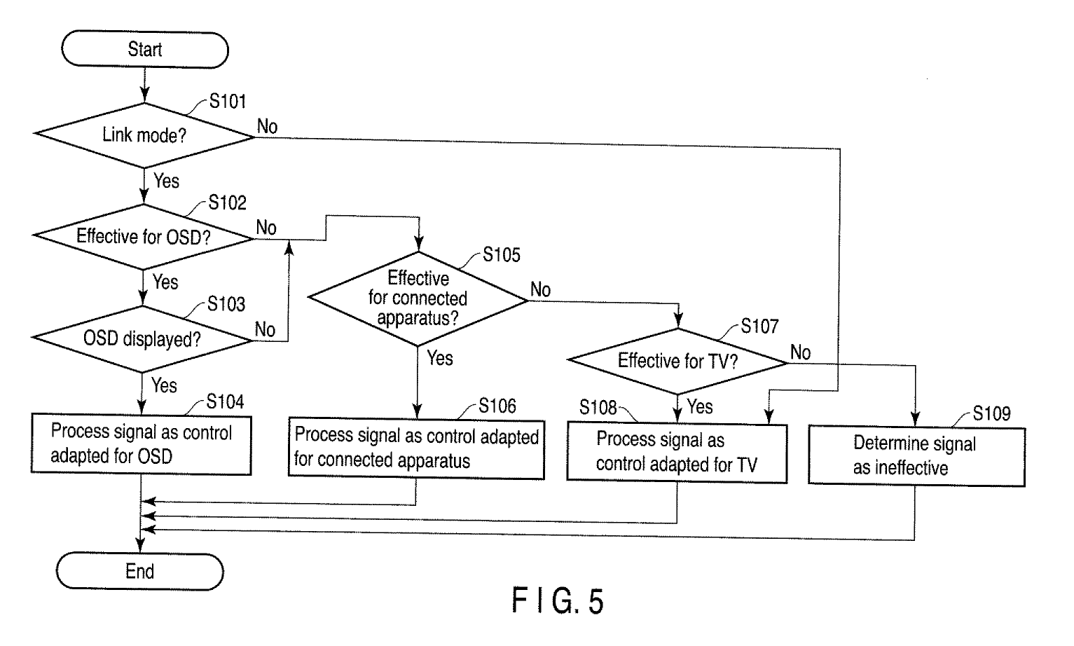

A control method applicable to the electronic apparatus of this embodiment will now be described with reference to the flowchart shown in FIG. 5.

When the television 10 receives a control signal (remote control code) transmitted from the remote control unit 13, the television 10 determines whether it is set to a “link mode” or not (block S101). In block S101, if it is determined that the television 10 is set to the “link mode” (YES in block S101), the television 101 determines whether the received control signal (remote control code) is a control signal effective for the on-screen display 100 (block S102). In block S102, if it is determined that the received control signal (remote control code) is a control signal effective for the on-screen display 100, that is, if the received control signal (remote control code) is a control signal (remote control code) assigned to the direction keys (up and down keys) 113 and 114 (FIG. 3) of the remote control unit 13 (YES in block S102), the television 10 determines whether the on-screen display 100 is displayed or not (block S103).

In block S103, if the television 10 determines that the on-screen display 100 is displayed (YES in block S103), the television 10 processes the received control signal (remote control code) as control corresponding to the on-screen display 100 (block S104). For example, if the received control signal (remote control code) is a control signal (remote control code) corresponding to the direction keys (up and down keys) 113 and 114 of the remote control unit 13, the television 10 selects a target input source from the input sources (FIG. 6) displayed on the on-screen display 100 and switches the current input source of the television 10 to the selected input source. More specifically, a plurality of items respectively corresponding to a plurality of input sources are displayed on the on-screen display 100. The items corresponding to input sources that are candidates for selection are highlighted. For example, each time the direction key (up or down key) 113 or 114 is operated by the user, the highlighted item is moved up or down.

Thus, if the control signal received from the remote control unit 13 is a control signal effective for an external apparatus and also effective for the on-screen display 100 (a control signal for switching input sources), in other words, if the received control signal is a control signal adapted for both the control of the external apparatus and the control of a selecting operation for the operation menu displayed as the on-screen display 100, the television 10 determines whether the on-screen display 100 is displayed or not. Then, on the condition that the on-screen display 100 is displayed, the television 10 processes the received control signal (remote control code) as a control signal adapted for the on-screen display 100. Thus, the control unit 21 executes the process for switching among input sources in accordance with the received control signal.

On the other hand, if it is determined that the television 10 is not in the “link mode” but in the “TV mode” (NO in block S101), the television 10 processes the received control signal (remote control code) as a control signal adapted for the television 10 (block S108).

In block S102, if the television 10 determines that the received control signal (remote control code) is not a control signal effective for the on-screen display 100, for example, that the received control signal (remote control code) is a control signal adapted for the direction key (left or light key) 115 or 116 of the remote control unit 13 (FIG. 3) (NO in block S102), the television 10 determines whether the received control signal (remote control code) is a control signal effective for the external apparatus (connected apparatus) 12 (block S105). In block S105, if it is determined that the received control signal (remote control code) is a control signal effective for the external apparatus 12 (YES in block S105), the television 10 processes the received control signal (remote control code) as a control signal adapted for the external apparatus (connected apparatus) 12 (block S106). In block S106, the television 10 transmits the received control signal (remote control code) to, for example, the external apparatus (connected apparatus) 12 through the HDMI cable 11 to control the external apparatus (connected apparatus) 12.

In block S105, if it is determined that the received control signal is not a control signal effective for the external apparatus 12 (NO in block S105), the television 10 determines whether the received control signal (remote control code) is a control signal effective for the television 10 (block S107). In block S107, if it is determined that the received control signal is effective for the television 10 (YES in block S107), the television 10 processes the received control signal (remote control code) as a control signal to control the operations of the television 10, and executes the process designated by the received control signal (remote control code) (block S108). If it is determined that the received control signal is not effective for the television 10 (NO in block S107), the television 10 regards the signal as an ineffective control signal and terminates the process (block S109).

An object of the present invention is to provide an electronic apparatus and display control method, which can operate an operation menu for switching inputs displayed in a television even when operation buttons corresponding to both the operation menu and an external apparatus are pushed.

As described above, according to this embodiment, if the received control signal is adapted for both the control of the external apparatus and the selecting operations for the operation menu displayed as the on-screen display 100, the television 10 determines whether the on-screen display 100 is displayed or not. Depending on the determination result, the television 10 selectively executes the process of switching among input sources according to the received control signal or the process of transmitting the received control signal to the external apparatus. Therefore, the switching among input sources can be carried out even in the link mode.

The present invention is not limited to the above embodiment only, but the elements thereof can be modified without departing from the spirit or scope of the invention when practiced.

Further, some of the plurality of elements of the above embodiment described above may be suitably combined, so that various inventions may be achieved. For example, some of the elements may be deleted from all elements of the embodiment. Furthermore, elements of different embodiments may be suitably combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electronic apparatus which displays image data input from an input source on a display screen, the apparatus comprising:
a communication unit which communicates with an external apparatus;
a menu display processing unit which displays an operation menu to operate the electronic apparatus on the display screen;
a receiving unit which receives a control signal transmitted from a remote control unit; and
a control unit which determines whether the operation menu is displayed on the display screen when the control signal received by the receiving unit is a control signal adapted for both control of the external apparatus and operation of the operation menu, and executes operation of the operation menu in accordance with the received control signal when the operation menu is displayed on the display screen.

2. The electronic apparatus of claim 1, wherein the control unit transmits the received control signal to the external apparatus via the communication unit when the operation menu is not displayed on the display screen.

3. The electronic apparatus of claim 1, wherein the input source is selected from a plurality of input sources and the operation menu includes a menu to switch among the input sources.

4. The electronic apparatus of claim 3, further comprising a tuner configured to receive a broadcast wave, wherein the broadcast wave that has been received by the tuner is input by switching among the input sources.

5. The electronic apparatus of claim 1, wherein when the operation menu is displayed on the display screen and a control signal adapted for the external apparatus is received through the receiving unit, the operation menu is erased and the control signal is processed as a control signal adapted for control of the external apparatus.

6. The electronic apparatus of claim 1, wherein the menu display processing unit switches on/off of the operation menu in accordance with the control signal received by the receiving unit.

7. A control method used in an electronic apparatus which displays image data input from an input source on a display screen, the electronic apparatus comprising: a communication unit which communicates with an external apparatus; a menu display processing unit which displays an operation menu to operate the electronic apparatus on the display screen; and a receiving unit which receives a control signal transmitted from a remote control unit, the method comprising:
determining whether the operation menu is displayed on the display screen when the control signal received by the receiving unit is a control signal adapted for both control of the external apparatus and operation of the operation menu, and executing operation of the operation menu in accordance with the received control signal when the operation menu is displayed on the display screen.
